(19) United States
(12) Patent Application Publication
(10) Pub. No.: US 2002/0005970 A1
(43) Pub. Date: Jan. 17, 2002

(54) Dispersion compensator and method of compensating for dispersion

(76) Inventor: Thiemo Lang, Goppingen (DE)

Correspondence Address: LERNER AND GREENBERG, P.A., PATENT ATTORNEYS AND ATTORNEYS AT LAW, P.O. Box 2480, Hollywood, FL, 33022-2480, US

(21) Appl. No.: 09/845,855

(22) Filed: Apr. 30, 2001

(30) Foreign Application Priority Data
Apr. 28, 2000 (DE) 100 20 951.3

(51) Int. Cl. G02B 6/00; H04B 10/00

(52) U.S. Cl. 359/161; 385/122

(57) ABSTRACT

The method for dispersion compensation and the dispersion compensator that carries out the method, split an optical signal into two frequency bands f_{H} and f_{L}. The frequency bands are transmitted in two Mach-Zehnder arms, where they are subjected to different propagation delays. When the frequency bands are recombined, they are polarized orthogonally with respect to one another.

### BACKGROUND OF THE INVENTION

1. Field of the Invention

The invention lies in the field of optics technology. More specifically, the invention relates to an optical dispersion compensator, preferably for use preceding an optical transmission link or following an optical transmission link, comprising at least one optical input, at least one frequency demultiplexer (FDM) which splits incoming signals with an input spectrum into two frequency bands f_{L} and f_{H} and two transmission links (Mach-Zehnder-Arms) of different optical lengths each of which is supplied with a frequency band (f_{L}, f_{H}), the optically longer Mach-Zehnder arm being used as delay line, and then at least one frequency recombination unit in which the two spectrally divided signals are recombined and conducted to at least one optical output.

The invention also relates to a method of compensating for the dispersion of an optical signal, transmitted via an optical fiber, having a frequency spectrum composed of two frequency bands f_{H} and f_{L}. The frequency bands are split to one Mach-Zehnder arm each, subjected to different propagation delays, and then combined again.

During the transmission of optical signals of a particular frequency spectrum (a particular band width) via an optical conductor of great length, for example an optical fiber, dispersion phenomena occur due to the frequency-dependent velocity of propagation of the light in the optical fibers, that is to say a distortion of the input light pulse/input bit sequence in dependence on the path length. This chromatic dispersion of the optical fibers limits the maximum distance which can be spanned with the high-bit-rate transmission systems. Thus, for example, the usual single-mode optical fibers with a dispersion of 17 ps/nm km at a wavelength of 1550 nm allow a distance of only 80-100 km (50-65 miles) in 10 Gbit/s systems which can be spanned without dispersion compensation. Any further doubling of the transmission band width reduces the maximum distance which can be spanned roughly by a factor of 4. The dispersion of the optical fiber must then be correspondingly compensated for in the case of longer transmission links.

Due to their significance for the high-bit-rate transmission systems, there are a very large number of previously known methods for dispersion compensation. They can be roughly divided into electronic compensation techniques and optical compensation techniques.

Among the electronic compensation methods, there are firstly the pre-chirp techniques. They are based on generating a negative frequency chirp of the laser diode, thus providing for appropriate precompensation. Furthermore, a reduction of the input band width can be achieved by suitable modulation methods such as single-sideband modulation, duo-binary modulation etc. and thus the maximum distance which can be spanned can be increased, the bit rate remaining the same.

The electronic compensation techniques are generally quite cumbersome and their implementation depends on the bit rate to be transmitted. A further problem consists in that electronic compensation techniques are not optically transparent.

In the optical compensation methods, attempts are made to simulate the dispersion of the transmission link by a corresponding opposite dispersion of the optical compensation element as completely as possible. With an optimum simulation of the dispersion including the higher-order dispersion terms and disregarding the non-linear effects, a complete compensation can be potentially achieved.

For the optical dispersion compensation, special dispersion compensating fibers (DCFs) were developed which are now widely used in optical transmission systems. In this case, a bit sequence passes through the appropriately dimensioned DCF either before or after the actual dispersive transmission link section. Given the dispersion values of the DCFs which are currently achieved, a DCF length of approximately 15 km is needed for compensating for a 100 km transmission link via standard single-mode fibers.

Although these DCFs are optically transparent and allow for multi-channel compensation, they suffer from not being very compact, have an attenuation which is not negligible, and have no adjustable dispersion. The length of the DCF must be appropriately readjusted for each transmission link which entails additional logistical problems.

Another optical compensation technique is based on the “chirped” Bragg gratings (implemented fiber-optically or integrated optically). Although the “chirped” Bragg gratings are somewhat more compact than the DCFs, they operate in reflection mode and must thus be combined with a circulator. Moreover, the dispersion band width of a grating is limited and each individual wavelength channel must be separately compensated for. Furthermore, Bragg gratings which can be adjusted over a wide range of dispersion cannot be easily achieved because, in addition, the compensation band width and the reflection coefficient are dependent on the adjusted dispersion.

Another possibility consists in implementing dispersion compensation circuits by integrated optical means in planar technology, fiber-optically or volume-optically with the aid of interferometric configurations. The interferometric configurations are based on the use of asymmetric Mach-Zehnder interferometers, ring resonators or the Fabry-Perot resonators.

Regarding the compensation techniques described above, relating to Mach-Zehnder, reference is had to the following documents:

K. Takiguchi, K. Okamoto and K. Moriwaki, “Planar Lightwave Circuit Dispersion Equalizer”, J. Lightwave Technol., vol. 14, pp. 2003-11, 1996;

K. Takiguchi, S. Kawanishi, H. Takara, A. Himeno. K. Hattori, “Dispersion Slope Equalizer for Dispersion Shifted Fiber Using a Lattice-Form Programmable Optical Filter on a Planar Lightwave Circuit”, J. Lightwave Technol., vol. 16, pp. 1647-56, 1998; and

K. Jinguji, M. Kawachi, “Synthesis of Coherent Two-Port Lattice-Form Optical Delay-Line Circuit”, J. Lightwave Technol., vol. 13, pp. 73-82, 1995;

Relating to ring resonators and Fabry-Perot, reference is had to the following reference:

C. K. Madsen, G. Lenz, ‘Optical All-Pass Filters for Phase Response Design with Applications for Dispersion Compensation”, IEEE Photon. Technol. Lett., vol. 10, pp. 994-96, 1998.

The contents of the foregoing references are herewith incorporated by reference.

A technical problem of the above-mentioned interferometric structures consists in that, without cascading, they only provide for very limited dispersion compensation while simultaneously requiring a wide dispersion band width. The cascading necessary for this, in turn, unavoidably leads to a structure which is increasingly more difficult to implement and is more complex.

### SUMMARY OF THE INVENTION

The object of the present invention is to provide a dispersion compensator and a method for compensating for dispersion which overcome the above-noted deficiencies and disadvantages of the prior art devices and methods of this general kind, and wherein the system is capable of compensating for high dispersion values without cascading a number of filter stages and which, at the same time, has a wide band width. Furthermore, the invention is intended to make it possible to generate adjustable dispersion values.

With the above and other objects in view there is provided, in accordance with the invention, an optical dispersion compensator, comprising:

an optical input receiving an incoming signal having an input spectrum;

a frequency demultiplexer connected to the input and configured to split the incoming signal into two frequency bands;

two transmission links formed as Mach-Zehnder arms connected to the frequency demultiplexer and each receiving a respective one of the two frequency bands, the transmission links including an optically shorter transmission link and an optically longer transmission link acting as a delay line;

a polarization converter connected in at least one of the two transmission links; and

at least one frequency recombination unit connected to the two transmission links for recombining the signals received from the first and second transmission links, and an optical output for outputting the combined signal.

The dispersion compensator is preferably connected to receive the incoming signal from an optical transmission link and/or to output an optical signal recombined from the spectrally divided signals to an optical transmission link.

In further summary, the inventor proposes here a structure which provides for high dispersion compensation at any dispersion band width without cascading a number of filter stages. It is based on combining the two part-signals of an asymmetric Mach-Zehnder without forming interference in spite of an existing coherence. This is possible when the two signals are mutually orthogonally polarized when the signal is being recombined.

According to this concept of the invention, the optical dispersion compensator is improved —and specifically suitable for use preceding an optical transmission link or following an optical transmission link —in that there are provided at least one optical input, at least one frequency demultiplexer (FDM) which splits incoming signals having an input spectrum into two frequency bands f_{L} and f_{H} and two transmission links (Mach-Zehnder arms) of different optical lengths, each of which is supplied with a frequency band (f_{L}, f_{H}), the optically longer Mach-Zehnder arm being used as delay line, and then at least one frequency recombination unit in which the two spectrally divided signals are recombined and conducted to at least one optical output, to such an extent that a polarization converter is provided in at least one Mach-Zehnder arm. This is preferably the Mach-Zehnder arm having the shorter optical length for constructional considerations.

According to the invention, this dispersion compensator can be mounted either preceding or following an optical data transmission link.

In accordance with an added feature of the invention, the frequency recombination unit is a TE/TM polarization combiner or a 3-dB coupler.

In accordance with an additional feature of the invention, at least one of the transmission links is split into two or more partial links. A driven 1×N switch and a driven N×1 switch are provided (N is an integer >1) and N partial links are connected between the switches. Preferably, the 1×N switch and the N×1 switch are thermo-or electro-optically driven.

In accordance with another feature of the invention, a TE/TM phase shifter is connected in at least one of the transmission links. The TE/TM phase shifter may be connected behind, i.e., downstream of, the polarization converter.

With the above and other objects in view there is also provided, in accordance with the invention, an optical signal link which comprises a dispersion compensator as outlined above and a polarization controller connected upstream of the optical input of the dispersion compensator.

In accordance with a further preferred embodiment, the polarization controller is formed with two Mach-Zehnder arms and a phase shifter in at least one of the Mach-Zehnder arms.

Furthermore, the polarization controller further comprises a TE/TM divider at an input and a frequency recombination unit at an output thereof, and the two Mach-Zehnder arms of the polarization controller are connected between the TE/TM divider and the frequency recombination unit.

In accordance with again another feature of the invention, a polarization converter is connected in at least one of the Mach-Zehnder arms of the polarization controller.

The optical signal link is further characterized in that the polarization controller further comprises a bipolar polarization converter and mode sorter at an input thereof and a frequency recombination unit at an output thereof, and wherein the at least two Mach-Zehnder arms of the polarization controller are connected between the bipolar polarization converter and mode sorter and the frequency recombination unit.

With the above and other objects in view there is also provided, in accordance with the invention, an optical signal link formed with the dispersion compensator outlined above and a polarization scrambler and a polarizer (TE mode or TM mode) connected to the optical input of the dispersion compensator.

As noted above, an advantageous refinement of the dispersion compensator provides for the multiplexer to be implemented in the form of a TE/TM polarization combiner. This is possible if the two recombination signals supplied orthogonally are polarized in accordance with the respective principal axes (TE and TM). In this case, the two signals are theoretically combined without 3 dB power loss. As an alternative, a 3 dB coupler can also be used which then, however, causes the power loss.

In addition, the dispersion compensator can be designed in such a manner that at least one Mach-Zehnder arm, preferably the arm having the longer optical length and/or without polarization converter, is split into at least two part-links (into N part-links in general), in which case a drivable 1×N switch, a drivable N×1 switch and N part-links between the switches are provided. The result is that the delay time of the part-frequency band, and thus the achievable dispersion, becomes adjustable.

In this refinement of the dispersion compensator according to the invention, the 1×N switch and N×1 switch can be operated, for example, thermo-optically or electro-optically, without excluding other variants.

If there is no linearly polarized polarization state at the input of the compensator or there is a linearly polarized input state which does not correspond to the directions of the principal axis of the wave guides of the compensator and, at the same time, the wave guides of the compensator are anisotropically constructed, the two signals with the different frequency bands are no longer orthogonally polarized when they are being combined.

To recover the orthogonality in this case, it is also proposed in a special refinement of the invention that a fast controllable TE/TM phase shifter is arranged in at least one transmission link of the Mach-Zehnder, preferably behind the polarization converter. This makes it possible to ensure the orthogonality of the recombination signals when they are being combined by suitably driving the TE/TM phase shifter in the case of anisotropic wave guides.

If the dispersion compensator is to be used following an optical signal link, it may be appropriate or even necessary to linearize the polarization state coming into the dispersion compensator. This can be done by using a polarization controller in front of the dispersion compensator. This polarization controller can be implemented by a TE/TM divider at the input and a frequency recombination unit (multiplexer) at the output, one of the two Mach-Zehnder arms being equipped with a polarization converter and one of the two Mach-Zehnders being equipped with a fast controllable phase shifter.

In another embodiment of the signal link, the polarization controller is implemented by means of a bipolar polarization converter and mode sorter at the input and a frequency recombination unit (multiplexer) at the output where here, too, one of the two Mach-Zehnder arms needs a fast controllable phase shifter.

When the dispersion compensation element is mounted after the transmission link, there is also the possibility of mounting a fast polarization scrambler in front of the compensator and then a TE mode or TM mode polarizer. This also provides for a homogenous linear input polarization state in the compensator, an additional 3 dB power loss having to be accepted in this configuration.

With the above objects in view there is also provided, in accordance with the invention, a method of compensating for a dispersion of an optical signal. The method comprises the following method steps:

transmitting an optical signal via an optical fiber, the optical signal having a frequency spectrum composed of two frequency bands f_{H} and f_{L}, splitting the frequency bands into one Mach-Zehnder arm each, and subjecting the frequency bands to different propagation delays; and

recombining the two frequency bands transmitted in the two Mach-Zehnder arms and polarized orthogonally with respect to one another when they are combined.

In other words, in the method for compensating for dispersion of an optical signal transmitted via an optical fiber, having a frequency spectrum composed of two frequency bands f_{H}, f_{L}, the frequency bands being split to one Mach-Zehnder arm each, being subjected to different propagation delays and then being combined again, which is characterized in that the two frequency bands are polarized orthogonally with respect to one another when they are combined.

It must also be pointed out that the compensator can be implemented fiber-optically, volume-optically and/or integrated optically. Naturally, care must be taken to see that the components used do not generate any additional rotations in the polarization states.

Other features which are considered as characteristic for the invention are set forth in the appended claims.

Although the invention is illustrated and described herein as embodied in a dispersion compensator and method for compensating for dispersion, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic view illustrating the elementary functions of an (integrated-optical, fiber-optical or volume-optical) dispersion compensator based on a frequency demultiplexer, an asymmetric Mach-Zehnder and a frequency recombination unit, according to the prior art;

FIG. 2 is a diagrammatic view illustrating the principle of dispersion compensation by cascading an asymmetric Mach-Zehnder interferometer;

FIG. 3 is a diagram illustrating dispersion compensation analogously to FIG. 1 but additionally with the installation of a polarization converter in one of the two interferometer arms;

FIG. 4 is a diagram showing dispersion compensation as in FIG. 3 but with adjustable delay line for the f_{H} band of the spectrum;

FIG. 5 is a diagram showing dispersion compensation as in FIG. 4 but expanded by a TE/TM phase shifter for compensating for birefringent wave guides at any homogenous elliptical input polarization state;

FIG. 6a illustrates dispersion compensation as in FIG. 4 but with a preceding polarization controller;

FIG. 6b illustrates another version of the dispersion compensation as in FIG. 4 with a preceding polarization controller; and

FIG. 7 illustrates dispersion compensation as in FIG. 4 but expanded by a preceding polarization scrambler followed by a TE polarizer.

### DESCRIPTION OF THE PREFERRED EMBODIMENTS

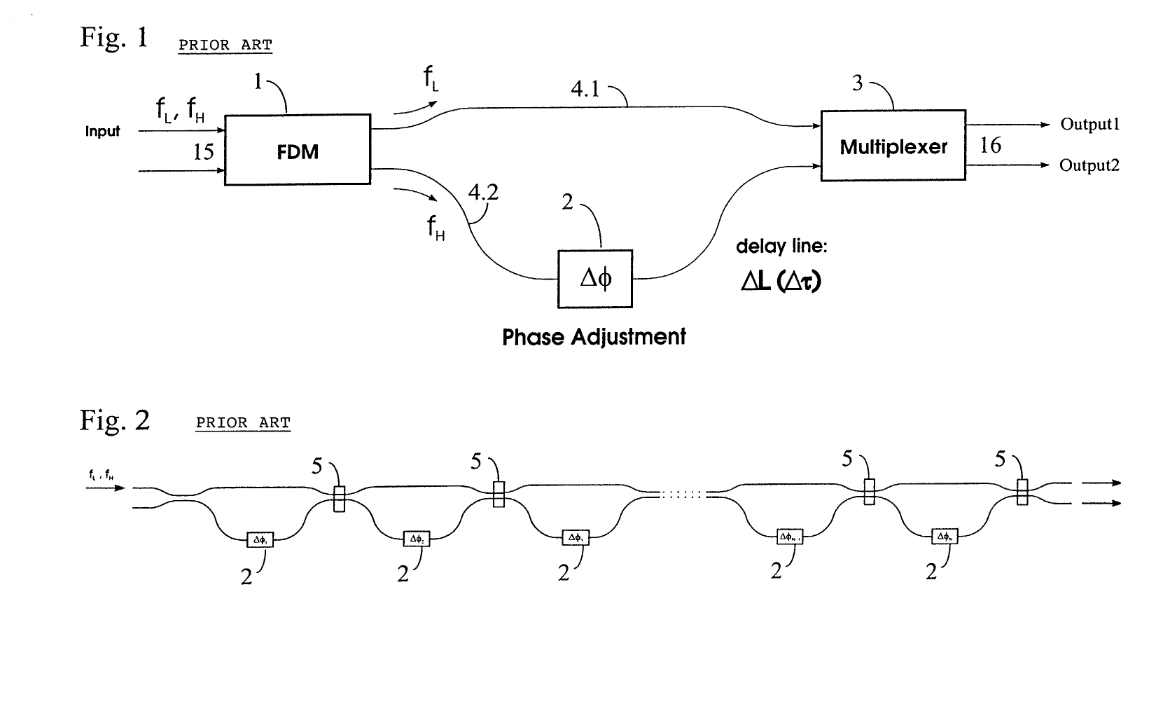

Referring now to the figures of the drawing in detail and first, particularly, to FIG. 1 thereof, there is seen a diagrammatic illustration of a prior art assembly for compensating for dispersion with the aid of an asymmetric Mach-Zehnder interferometer having an input 15 and two outputs (output 1 and output 2) at 16. The elementary functions necessary for compensating for dispersion such as the spectral division of the signal with the aid of a frequency division multiplexer (FDM) 1, the spectrum-dependent time delay ΔL (Δτ) and the signal recombination in a multiplexer 3 are implemented on a common starting substrate in the case of an integrated implementation.

In the example according to FIG. 1, the input frequency spectrum f_{L}, f_{H} of the signal is divided by the FDM 1 into two frequency bands f_{H} (high frequencies) and f_{L} (low frequencies) to the two Mach-Zehnder arms 4.1 and 4.2. As is also shown in FIG. 1, an adjustable phase shifter 2 for adjusting the phase difference ΔΦ, which may be based on the thermo-optical or electro-optical effect, is additionally necessary for precise phase calibration in one of the interferometer arms. Following this, the separated signals are recombined via the multiplexer 3.

This configuration represents a filter stage. The phase relationship of the waves interfering in the multiplexer 3 must not change too much as a function of the frequency in order to be able to achieve the desired compensation band widths without much intensity and time delay ripple. However, this requirement limits the maximum achievable delay time Δτ, and thus the dispersion per filter stage.

As a consequence, it is only possible to achieve large dispersion compensation over a great band width by cascading a number of asymmetric Mach-Zehnders (filter stages) . Such an implementation, normally used in the prior art, is shown in FIG. 2. The individual asymmetric Mach-Zehnder interferometers are here connected to one another by directional couplers 5 and, at the same time, fulfill the functions of frequency division multiplex, frequency-dependent delay, and frequency division demultiplex.

Due to the cascading, a progressive coherent overloading of the wave components of the two interferometer arms is generated. The greater the desired dispersion compensation with simultaneous large band width, the more cascading stages are required. Thus, the implementation becomes increasingly more difficult, especially since the optical path length or, respectively, the phase of each interferometer or, respectively, of each filter stage, must be precisely monitored. This may be done by a thermo-optical phase shifter. Configurations with virtually arbitrarily adjustable compensation values, possibly by means of adjustable couplers, are conceivable but again increase the complexity.

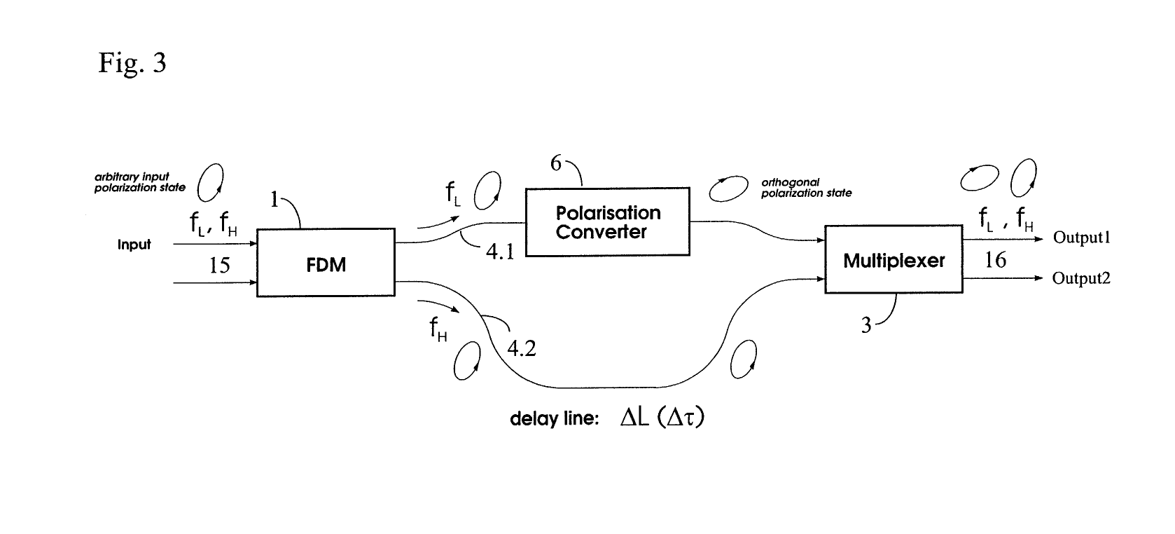

FIG. 3 shows a structure according to the invention of an optical dispersion compensator analogously to FIG. 1. Here, however, a polarization converter 6 is additionally inserted in the Mach-Zehnder arm 4.1 (interferometer arms). The aim is to achieve a signal recombination of two frequency bands without interference being formed due to their orthogonal polarization states. By appropriately dimensioning ΔL (difference in length of the Mach-Zehnder arms), time delays Δτ of the frequency band f_{H} can be achieved which have any magnitude, and this with a total band width of the signal f_{L}+f_{H} which, at the same time, is of any magnitude.

The assembly firstly consists of the frequency demultiplexer (FDM) 1 which divides the input spectrum into two frequency bands f_{L} and f_{H}. The FDM 1 ideally has a rectangular frequency response, i.e. having edges which drop off as steeply as possible. In the asymmetric Mach-Zehnder interferometer following, the two frequency bands f_{L} and f_{H} are subjected to a different propagation delay. In the case of isotropic and, at the same time, polarization-maintaining wave guides as is basically possible, for example, with an integrated optical form of implementation, the polarization input state as drawn in FIG. 3 can have any elliptical shape. The polarization states are specified by the configuration of the ellipses shown. The polarization converter then converts the signal of the Mach-Zehnder arm 4.1 from an arbitrarily elliptically polarized state into an elliptically polarized signal which is orthogonal thereto. This signal is then combined with the time-delayed signal from the Mach-Zehnder arm 4.2 in the multiplexer 3.

The multiplexer 3 in which the two frequency bands are combined and superimposed again may consist, in a simple implementation, of a broad band 3 dB coupler which entails an additional power loss of about 3 dB. In that case, an output of the multiplexer 3 can be used as monitor output. This can be used for monitoring the output power.

If, as shown in FIG. 3, the configuration consists of isotropic wave guides, an arbitrary elliptical polarization state of the input signal is permissible for its correct operation and the ellipse should be as identical as possible over the entire channel band width. In the case of a linear input polarization state with identical axes, the multiplexer can be implemented by a TE/TM polarization combiner which makes it possible to combine the signals without 3 dB power loss.

In the case of weakly or non-dispersive wave guides, the dispersion of the transmission link is only roughly approximated by the two-stage time delay which, however, can lead to a considerable improvement in the signal. Suitable dimensioning of the delay line ΔL can result in a two-stage time delay Δτ of any magnitude without cascading which means considerable simplification, especially in the case of large compensation values. Furthermore, the configuration manages without an adjustable phase shifter. The configuration thus needs no further corrective control with permanently set FDM, polarization converter and multiplexer.

If the dispersion of the transmission link is to be simulated ideally, it can be attempted to use in the Mach-Zehnder arms dispersive wave guides which have to be especially developed for the purpose.

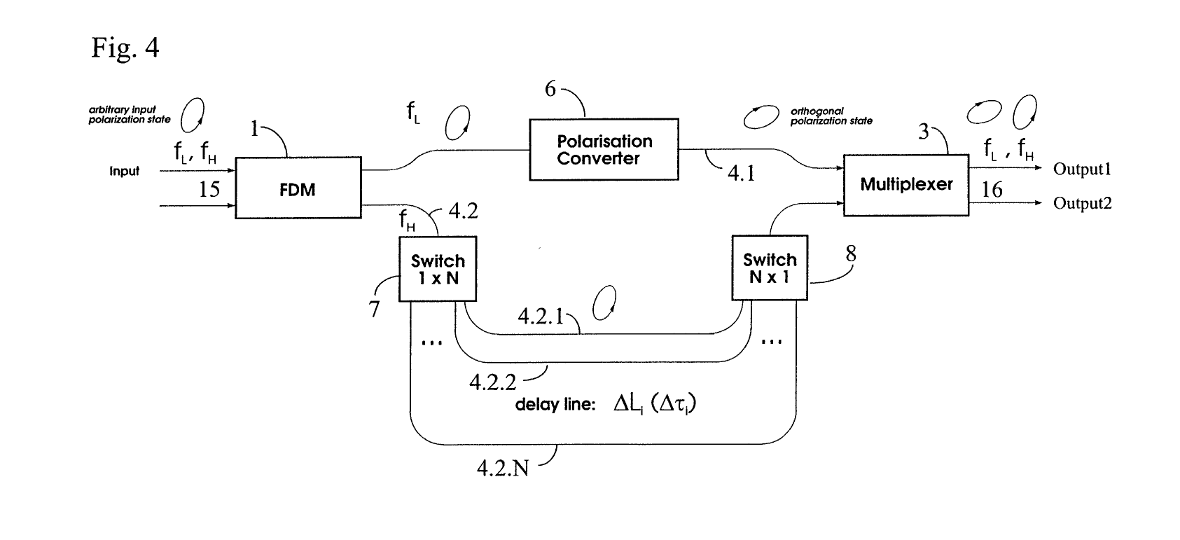

FIG. 4 shows a variant of the structure shown in FIG. 3 with adjustable time delay. For this purpose, two adjustable switches 7 and 8 which, depending on how they are driven, apply the f_{H} band of the spectrum to a corresponding delay line of different length 4.2.1 . . . 4.2.N, are inserted in the Mach-Zehnder arm 4.2. The switches can be driven, for example, thermo-optically or electro-optically. This configuration, too, does not need any phase shifter for precise phase calibration.

The configuration shown in FIG. 4 requires, analogously to FIG. 3, ideally either an identical homogenous input polarization state over the entire channel frequency band width and, at the same time, isotropic wave guides, or a linear TE or TM input polarization state with arbitrarily anisotropic wave guides to function correctly. The configurations according to FIGS. 3 and 4 are, therefore, particularly suitable for dispersion compensation preceding the transmission link, for instance directly following the transmit laser with its defined linear polarization state.

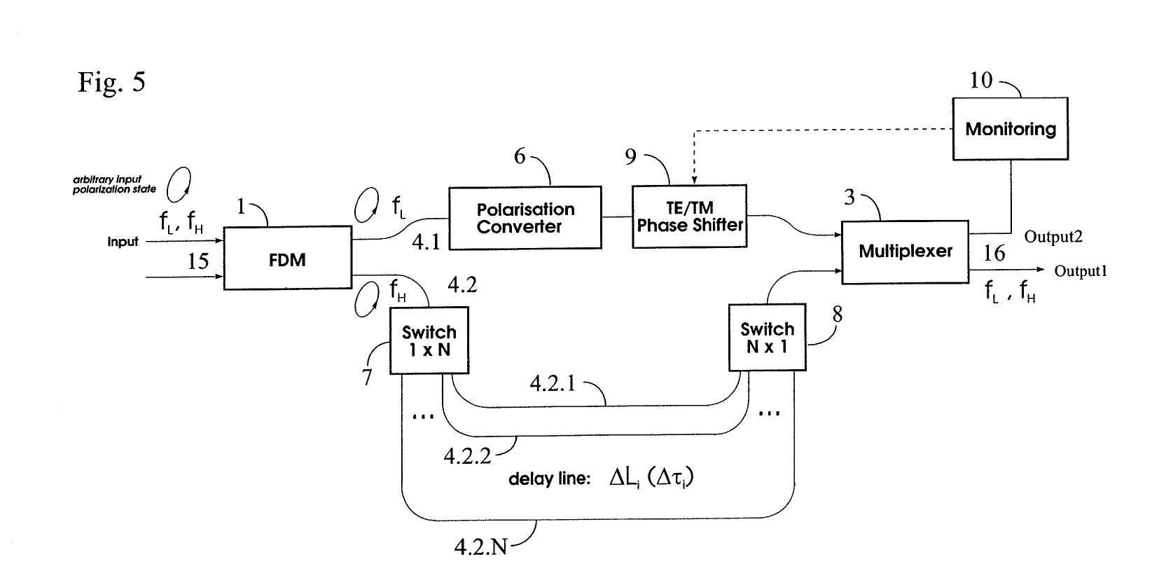

If the configuration according to FIG. 4 can only be implemented by means of anisotropic wave guides, it is necessary to use an adjustable TE/TM phase shifter 9 in one of the two Mach-Zehnder arms to obtain correct operation of the dispersion compensator with an arbitrary homogenous elliptical input polarization state. As shown in FIG. 5, this phase shifter can be arranged, for example, following the polarization converter 6. The phase shifter 9 ensures that the two interferometer signals in the Mach-Zehnder arms 4.1 and 4.2 are orthogonal when they are combined. In this configuration, the TE/TEM phase shifter 9 must compensate for the accumulated difference in anisotropy of the two Mach-Zehnder arms.

For the general case of anisotropic wave guides of the dispersion compensator, the input polarization state can also be rotated by an additional preceding polarization controller in such a manner that it is linearly polarized and, at the same time, corresponds to one of the wave guide axes of the dispersion compensator.

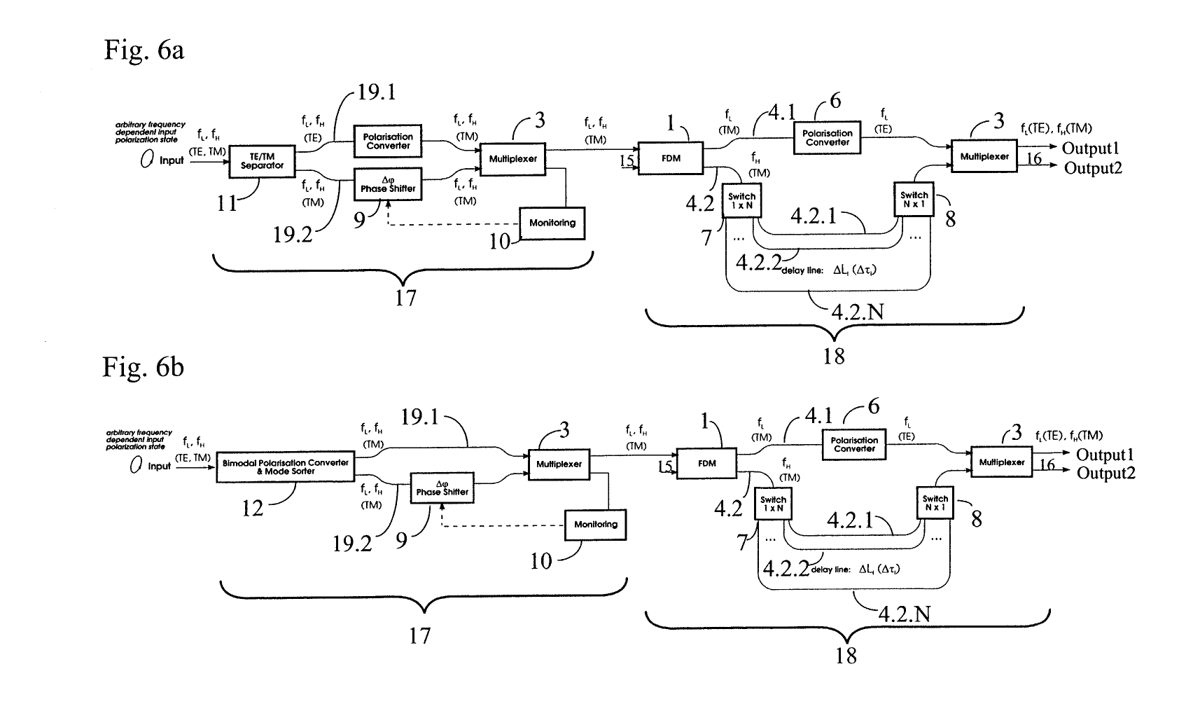

Such an embodiment can be indicated especially if the dispersion compensator according to the invention is used following a transmission link. As a supplement to the embodiments known in the literature, FIGS. 6a and 6b show two configurations which are possible for this purpose.

The polarization controller 17 of the configurations according to FIGS. 6a, 6b controls the polarization state in such a manner that it corresponds to the principal axes of the wave guides of the subsequent dispersion compensator 18 (TE or TM polarization). The principal axes of the wave guides of the subsequent dispersion compensator 18 are thus allowed to have any anisotropy. At the same time, the polarization controllers 17 of FIGS. 6a, 6b can be used for compensating for the polarization mode dispersion to a limited extent.

As a further variant for an application of the configurations following the transmission link as shown in FIGS. 3 and 4, it would be conceivable to use a preceding fast polarization scrambler 13 followed by a TE or TM polarizer 14. In this case, the wave guides 4.1, 4.2 of the dispersion compensator 18 are allowed to have any anisotropy since the input polarization state of the light wave is oriented in the direction of one of the principal axes (TE or TM polarization) by the preceding polarizer 14. The polarization scrambler 13 is used either at the link input or directly before the compensation element with the preceding polarizer. In any case, the polarizer should be used immediately preceding the actual compensator element.

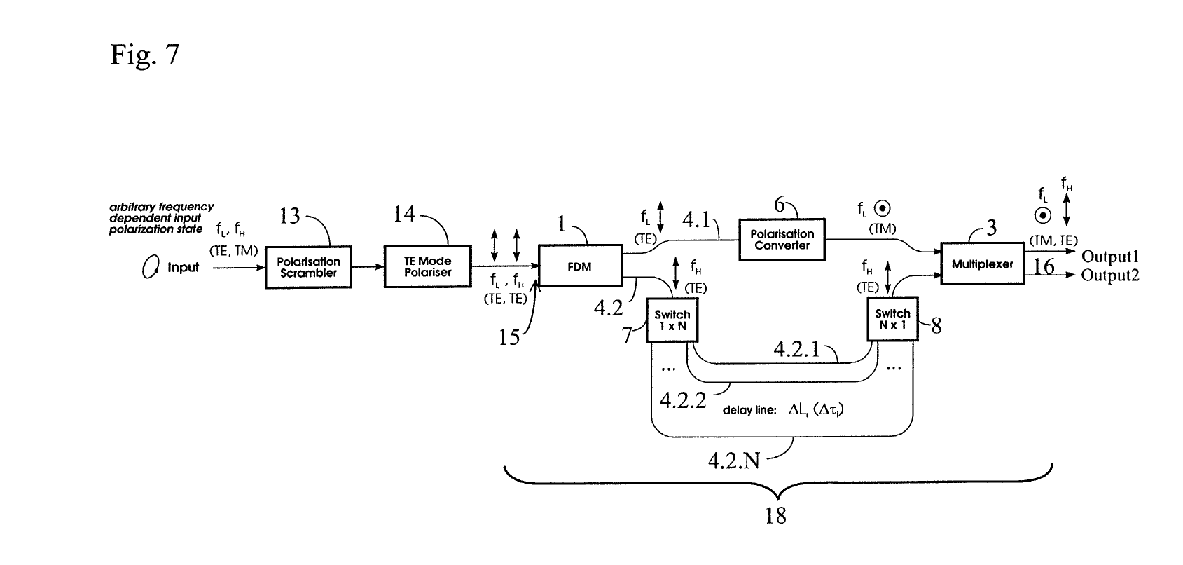

As an example, FIG. 7 shows a configuration with a polarization scrambler 13 and TE polarizer 14 directly preceding the dispersion compensator 18.

In this configuration with polarization scrambler and downstream polarizer, an additional power loss of 3 dB must be accepted.

All configurations described can be used for single-channel or multi-channel compensation in dependence on the nature of the transmission link. The configurations can be implemented either integrated-optically (on a common substrate in integrated or hybrid form), fiber-optically or with the aid of micro-optical (volume-optical) components.

Thus, the invention describes a method for compensating for dispersion and a dispersion compensator for carrying out the method, an optical signal being split into two frequency bands f_{H} and f_{L} and to two Mach-Zehnder arms, there being subjected to different propagation delays and the frequency bands subsequently being recombined and polarized orthogonally with respect to one another.

Overall, this invention provides a dispersion compensator and a method for compensating for dispersion which is able to compensate for high dispersion values without cascading a number of filter stages and, at the same time, has a great band width. Furthermore, the invention makes it possible also to generate adjustable dispersion values.

I claim:

1. An optical dispersion compensator, comprising:
an optical input receiving an incoming signal having an input spectrum;
a frequency demultiplexer connected to said input and configured to split the incoming signal into two frequency bands;
two transmission links connected to said frequency demultiplexer and each receiving a respective one of the two frequency bands, said transmission links including an optically shorter transmission link and an optically longer transmission link acting as a delay line;
a polarization converter connected in at least one of said transmission links; and
at least one frequency recombination unit connected to said transmission links for recombining the signals received from said transmission links, and having an optical output.

2. The dispersion compensator according to claim 1, wherein said first and second transmission links are Mach-Zehnder arms.

3. The dispersion compensator according to claim 1, wherein said input is connected to receive the incoming signal from an optical transmission link.

4. The dispersion compensator according to claim 1, wherein said optical output is connected to output an optical signal recombined from the spectrally divided signals to an optical transmission link.

5. The dispersion compensator according to claim 1, wherein said frequency recombination unit is a TE/TM polarization combiner.

6. The dispersion compensator according to claim 1, wherein said frequency recombination unit is a 3dB coupler.

7. The dispersion compensator according to claim 1, wherein at least one of said transmission links is split into at least two partial links, and wherein a drivable 1×N switch, a drivable N×1 switch, and N partial links are connected between said switches, wherein N is an integer.

8. The dispersion compensator according to claim 7, wherein said 1×N switch and said N×1 switch are thermo-optically driven.

9. The dispersion compensator according to claim 7, wherein said 1×N switch and said N×1 switch are electro-optically driven.

10. The dispersion compensator according to claim 1, which comprises a TE/TM phase shifter connected in at least one of said transmission links.

11. The dispersion compensator according to claim 10, wherein said TE/TM phase shifter is connected behind said polarization converter in an optical signal flow direction.

12. An optical signal link, comprising a dispersion compensator according to claim 1 and a polarization controller connected upstream of said optical input of said dispersion compensator.

13. The optical signal link according to claim 12, wherein said polarization controller is formed with two Mach-Zehnder arms and a phase shifter in at least one of said Mach-Zehnder arms.

14. The optical signal link according to claim 13, wherein said polarization controller further comprises a TE/TM divider at an input and a frequency recombination unit at an output thereof, and said two Mach-Zehnder arms of said polarization controller are connected between said TE/TM divider and said frequency recombination unit.

15. The optical signal link according to claim 14, which comprises a polarization converter connected in at least one of said Mach-Zehnder arms of said polarization controller.

16. The optical signal link according to claim 13, wherein said polarization controller further comprises a bipolar polarization converter and mode sorter at an input thereof and a frequency recombination unit at an output thereof, and wherein said at least two Mach-Zehnder arms of the polarization controller are connected between said bipolar polarization converter and mode sorter and said frequency recombination unit.

17. An optical signal link, comprising a dispersion compensator according to claim 1, and a polarization scrambler and a polarizer connected to said optical input of said dispersion compensator.

18. The optical signal link according to claim 17, wherein said polarizer is one of a TE mode and a TM mode polarizer.

19. A method of compensating for a dispersion of an optical signal, which comprises:
transmitting an optical signal via an optical fiber, the optical signal having a frequency spectrum composed of two frequency bands f_{H} and f_{L}, splitting the frequency bands into one Mach-Zehnder arm each, and subjecting the frequency bands to different propagation delays; and
recombining the two frequency bands transmitted in the two Mach-Zehnder arms and polarized orthogonally with respect to one another during the combining.
